(19) United States
(12) Patent Application Publication
(10) Pub. No.: US 2025/0117720 A1
(43) Pub. Date: Apr. 10, 2025

(54) Method to achieve 24/7 carbon-free electrified fleet operations

(71) Applicant: The Board of Trustees of the Leland Stanford Junior University, Stanford, CA (US)

(72) Inventors: Ram Rajagopal, Palo Alto, CA (US); Justin Ting Han Luke, Menlo Park, CA (US); Mateus Gheorghe De Castro Ribeiro, Stanford, CA (US); Gustavo Cezar, San Jose, CA (US); Liang Min, Pleasanton, CA (US)

(21) Appl. No.: 18/908,097

(22) Filed: Oct. 7, 2024

Related U.S. Application Data
(60) Provisional application No. 63/588,405, filed on Oct. 6, 2023.

(51) Int. Cl. G06Q 10/047; B60L 53/50; B60L 53/67

(52) U.S. Cl. CPC G06Q 10/047; B60L 53/50; B60L 53/67

(57) ABSTRACT

An electric vehicle fleet operations system includes electric vehicle charging stations; electric energy storage batteries; solar panels; a fleet of electric vehicles adapted to charge using the electric vehicle charging stations; a forecasting module predicting operational parameters including electricity prices, weather variables, power production of the solar panels, and emission factors of the electrical power distribution grid; a surrogate module predicting, based on the operational parameters, energy consumption of the fleet of electric vehicles; an optimization module adapted to compute, based on the operational parameters and the energy consumption, optimal operational tasks for the fleet of electric vehicles and for the electric energy storage batteries; and a communications subsystem adapted to communicate the operational tasks to the fleet of electric vehicles and to the electric energy storage batteries. The optimization module is adapted to determine optimal operational tasks by solving an optimization problem to minimize an objective function that selects the optimal operational tasks to simultaneously minimize electrical energy costs and emissions of the electrical power distribution grid.

### CROSS-REFERENCE TO RELATED APPLICATIONS

This application claims priority from U.S. Provisional Patent Application 63/588,405 filed Oct. 6, 2023, which is incorporated herein by reference.

### STATEMENT REGARDING FEDERALLY SPONSORED RESEARCH OR DEVELOPMENT

None.

### FIELD OF THE INVENTION

The invention relates generally to electric vehicle fleet operations. More specifically, it relates to systems for electric vehicle fleet operations that account for both energy costs and carbon emissions.

### BACKGROUND OF THE INVENTION

The intelligent coordination of a commercial electric vehicle (EV) fleet with PV solar generation, battery storage, electricity prices, and dynamic grid emissions can bolster the fleet's emissions reduction and lower its operating costs. In 2022, transportation accounted for 36% of United States energy consumption, and of that share, 90% was met by petroleum sources. This heavy petroleum dependence makes decarbonizing the transportation sector crucial to meet goals for zero greenhouse gas emissions from energy production. Rapid vehicle electrification is pushing the sector toward this goal, in light-, medium-, and heavy-duty vehicle fleets. One particular subset of the heavy-duty fleet that greatly benefits from electrification is buses, which often have short trips, frequent stops, benefits to urban air quality, and sufficient off-peak times for charging. However, the emissions associated with charging EVs must also be accounted for. For example, an EV charging exclusively from the US grid's most carbon-intensive power mix in 2019 produces more emissions than its hybrid counterpart.

To truly decarbonize electric bus charging, fleet operators must also carefully choose the carbon emissions accounting system that will inform their fleet charging. In contrast to volumetric matching of annual electricity consumption with carbon-free electricity (CFE) procurements, which yields negligible reductions to system-level emissions, temporal hourly-based CFE matching more consistently drives real system-level reductions while also incentivizing market uptake of clean firm power and long-duration storage, albeit potentially at a cost premium. To achieve temporal CFE matching at all hours and operate a 24/7 CFEF in a cost-effective manner, an intelligent system is required to coordinate bus service schedules, bus charging, electricity pricing, grid marginal emissions factors, and on-site CFE resources such as PV solar and battery storage.

There has been extensive work on coordinating bus charging with electricity pricing and bus assignment to blocks, which are sequences of trips an assigned bus performs before returning to the depot, without consideration of grid emissions. Besides works that solely focus on charging coordination to reduce electricity energy costs, other problem formulations have considered multiple cost components in objective, which include demand charges, deadheading costs, and battery degradation. Other formulations have also considered charging resource constraints, adapting to charger failures, and allowing for fast charging. A mixed-integer linear program (MILP) model is a common method to optimize for minimizing multiple objective terms while ensuring fleet operation requirements are satisfied. Other schedule planning techniques to reduce electricity costs include particle swarm optimization, Markov decision processes, Lagrangian relaxation for scalability, adaptive large neighborhood search, and nonlinear programming.

While some electric bus fleet operation frameworks do account for emissions, few works examine emissions, electricity demand charges, and optimization of battery energy storage simultaneously. While some works minimize emissions and find a carbon reduction, they do not jointly optimize for electricity costs, vehicle operations, and integration of battery storage. Critically, optimizing without factoring in demand charges could drastically misrepresent total costs, as demand charges can be up to 90% of the total electricity bill in a scenario with EV fast charging. Overall, electric bus fleet operators must view scheduling holistically to ensure a balance between costs, robust route and charging schedules, and emissions reductions.

Battery storage systems constitute a significant portion of the entire project cost, thus they should be managed such that their maximum value can be extracted. Electric bus charging complemented with co-located storage provides a cost and emissions reduction opportunity without disrupting charging schedules. To maximize the return on investment, system operators can “value stack” battery services, including peak shaving and arbitrage. However, as new solar NEM policies are introduced that reduce the revenue from exporting excess solar during the midday, such as NBT (also known as “NEM 3.0” in California), the value proposition of battery storage is increased. Based on preliminary reports, installed PV solar capacity has reduced since the introduction of NBT in California. Thus, it is important for frameworks to also consider NBT pricing to best optimize battery storage operations by storing excess solar and selling during high evening NBT prices. Some approaches optimize for storage and solar sizing for an EV fast charging station considering NEM, but do not examine the impacts of NBT, joint optimization of fleet vehicle operations, and emissions. Other approaches optimize for flexible load and storage under NBT but do not consider vehicle operations, emissions, or demand charges in commercial settings.

In summary, while many works design an electric bus scheduling algorithm that minimize electricity costs, they fail to account for various factors such as emissions and benefits from jointly optimizing co-located storage, costs, and both. Some works have studied an electric bus fleet, solar, and storage in a university campus setting, but they do not consider grid carbon intensity, potential demand charges incurred by the bus fleet and how they interact with other campus electricity load, joint optimization of bus-block assignments, or NBT pricing. Other works propose a methodology for emissions reduction of a fleet with co-located solar and storage, however, the emissions objective is simply an added fixed price to the electricity price and does not consider time-varying marginal emissions factors of grid electricity, joint optimization of bus-block assignments is not considered, and a technoeconomic analysis of the battery storage system and carbon pricing is not included.

### BRIEF SUMMARY OF THE INVENTION

In today's transportation sector, vehicle electrification has presented itself as the primary pathway to mitigate climate change. Nonetheless, to eliminate emissions and become carbon neutral, fleet operators should ensure that the energy demanded by upcoming and current electric vehicles is powered by carbon-free resources. Our invention provides a system to intelligently coordinate operations and charging schedules, distributed energy resources (DERs), such as solar panels and battery storage, and grid energy in electric vehicle fleets. The main goal of the invention is to reduce carbon emissions as much as possible while simultaneously minimizing operational costs, which include energy costs, while ensuring resiliency of operations.

The invention provides, in one aspect, a fully integrated method that coordinates electric vehicle fleet operations and charging schedules, energy resources, and battery storage in real time. We provide a specific embodiment of this invention that comprises of a forecasting module, a surrogate module for vehicle energy consumption, an optimization module, and known/determined system variables. The forecasting module predicts the signals of different components used in the system, such as solar power availability, grid marginal emission factors, and weather variables (e.g., temperature, solar radiation, daily rain, and others). The forecasting model can be of many types, such as, but not limited to, simple naive seasonal models, auto-regressive models, Long Short-Term Memory networks, attention-based time-series forecasting models, or others. The surrogate module predicts the energy consumption of the fleet's current electric vehicles inventory. It accounts for the uncertainty inherent due to the range of factors that can affect energy utilization, including, but not restricted to, driver behavior, aging of the vehicle battery, weather (which can affect traffic and/or the battery performance), vehicle occupancy, vehicle size (battery capacity), vehicle type (light, heavy or medium-duty), route or trip taken, and others. Such surrogate models may be of different natures, yet not limited to linear regression models, polynomial regressions, Gaussian processes, neural networks, support vector regression, or others. The optimization module determines assignments of tasks to each fleet electric vehicle, electric vehicle charging, and battery storage charging/discharging at minimum net cost, which comprises of electric utility energy costs and demand charges, energy revenue or cost offset from surplus clean power generation, operational costs and revenue, and carbon emissions cost. The optimization can be performed in many different ways, such as, but not limited to, solving a mixed-integer linear program (MILP) model, linear program (LP), or others. Known/determined variables are parameters established or already defined by the system user. Examples include, yet are not restricted to routes/trips distance and schedule, electric vehicle specifications such as battery size and charging rates, calendar and potential events that may disrupt regular operations, storage system specifications such as stationary battery capacity and charging/discharging rates, chargers specifications namely charger charging rate and number of ports, energy rates for instance demand rates and energy costs, price of carbon, state of charge set points or bounds for the electric vehicles and storage system, and others.

Potential applications are pieces of software that could (1) generate charging and operations schedule of the fleet; (2) control battery storage charging/discharging. Both applications can be determined jointly, in real time, and optimized to minimize net cost. Potential customers include (1) private and public transportation fleets in different scales, such as universities, schools, corporate campuses, autonomous fleets, airports, and/or municipalities; (2) researchers.

Significantly, the method provides an electric vehicle fleet operations/charging schedule platform that explicitly accounts for carbon emissions and energy costs simultaneously.

The inventors further envision (1) enhancing forecasts and methodology to ensure greater robustness; (2) validating the methodology by considering charging and operations scheduling in a real-world context such as the Stanford Marguerite system; (3) validating the methodology when a stationary battery is coupled to the system, which should occur in a horizon of months to a year also in a real-world context with the Stanford Marguerite system.

In one aspect, the invention provides an electric vehicle fleet operations system comprising: electric vehicle charging stations; electric energy storage batteries; solar panels; a fleet of electric vehicles adapted to charge using the electric vehicle charging stations; a forecasting module predicting operational parameters including electricity prices, weather variables, power production of the solar panels, and emission factors of the electrical power distribution grid; a surrogate module predicting, based on the operational parameters, energy consumption of the fleet of electric vehicles; an optimization module adapted to compute, based on the operational parameters and the energy consumption, optimal operational tasks for the fleet of electric vehicles and for the electric energy storage batteries; and a communications subsystem adapted to communicate the operational tasks to the fleet of electric vehicles and to the electric energy storage batteries. The electric vehicle charging stations, the electric energy storage batteries, and the solar panels are connected to each other and to an electrical power distribution grid. The optimization module is adapted to determine optimal operational tasks by solving an optimization problem to minimize an objective function that selects the optimal operational tasks to simultaneously minimize electrical energy costs and emissions of the electrical power distribution grid.

The surrogate model may use a Gaussian Process-based surrogate model comprising a probabilistic model that infers a distribution over data points based on known input-output values. Alternatively, the surrogate model may use linear regression models, polynomial regression, Gaussian Processes, neural networks, or support vector regression.

Preferably, the operational tasks for the fleet of electric vehicles include charging schedules and route assignments. Preferably, the operational tasks for the electric energy storage batteries include charging and discharging schedules.

Solving the optimization problem to minimize the objective function may use mixed integer linear programming. Alternatively, solving the optimization problem to minimize the objective function may use Reinforcement Learning-based methods.

### BRIEF DESCRIPTION OF THE SEVERAL VIEWS OF THE DRAWINGS

FIG. 1 is a schematic diagram of information flow in an electric vehicle fleet operations system according to an embodiment of the invention.

FIG. 2 is a schematic diagram of power flow between electric energy components of an electric vehicle fleet operations system according to an embodiment of the invention.

FIG. 3A shows graphs of PV solar power generation vs time, averaged over the days in January, April, July, and October 2023.

FIG. 3B shows graphs of PV solar power generated for CAISO marginal emissions factors, averaged over days in January, April, July, and October 2023.

FIG. 4 is a graph of electricity energy prices vs. time of day used for different case studies discussed in the present description.

FIG. 5A is a graph of power demand (positive) and supply (negative) vs. time for a baseline scenario.

FIG. 5B is a graph of power demand (positive) and supply (negative) vs. time for an optimized scenario.

FIG. 5C is a graph of electricity energy prices vs. time, where with the dotted line indicates a total price of the other graphed prices.

FIG. 6A is a bar graph comparing electricity savings during winter for three different scenarios: Bus+Battery, Battery Only, and Bus Only.

FIG. 6B is a bar graph comparing electricity savings during spring for three different scenarios: Bus+Battery, Battery Only, and Bus Only.

FIG. 6C is a bar graph comparing electricity savings during summer for three different scenarios: Bus+Battery, Battery Only, and Bus Only.

FIG. 6D is a bar graph comparing electricity savings during autumn for three different scenarios: Bus+Battery, Battery Only, and Bus Only.

FIG. 7A is a bar graph of emissions associated with campus depot energy consumption during winter, comparing the baseline and three control scenarios.

FIG. 7B is a bar graph of emissions associated with campus depot energy consumption during spring, comparing the baseline and three control scenarios.

FIG. 7C is a bar graph of emissions associated with campus depot energy consumption during summer, comparing the baseline and three control scenarios.

FIG. 7D is a bar graph of emissions associated with campus depot energy consumption during autumn, comparing the baseline and three control scenarios.

FIG. 8A is a bar graph showing annual electricity bill savings relative to baseline of an optimized campus depot.

FIG. 8B is a bar graph showing annual carbon emissions for Bus+Battery, Battery Only, and Bus Only scenarios.

FIG. 9 is a graph of cumulative savings from joint optimal control of bus and battery operations compared to battery only control, over a ten-year horizon, according to an embodiment of the invention.

FIG. 10A is a graph of power demand (positive) and supply (negative) vs. time at a stand-alone depot with NBT policy for a baseline scenario.

FIG. 10B is a graph of power demand (positive) and supply (negative) vs. time at a stand-alone depot with NBT policy for an optimized scenario.

FIG. 10C is a graph of electricity energy prices vs. time, were the black dashed line shows the summed total rate used to determine costs and the grey dashed line shows the NBT export rate used to determine revenue.

FIG. 11A is a graph or electricity bill vs. carbon price comparing optimization results for varying solar capacities.

FIG. 11B is a graph of emissions vs. carbon price comparing optimization results for varying solar capacities.

FIG. 11C is a graph or electricity bill vs. emissions comparing optimization results for varying solar capacities.

FIG. 12A is a bar graph showing optimized electricity bill savings for four different combinations of tariffs and net metering policies for winter weeks.

FIG. 12B is a bar graph showing optimized electricity bill savings for four different combinations of tariffs and net metering policies for summer weeks.

### DETAILED DESCRIPTION OF THE INVENTION

### Introduction

Electrifying a commercial fleet while concurrently adopting distributed energy resources can significantly reduce the cost and carbon footprint of its operation. However, coordinating the fleet operations with distributed resources requires an intelligent system to determine their joint dispatch. Herein is described a 24/7 Carbon-Free Electrified Fleet (CFEF) digital twin framework for the coordination of an electric bus fleet, co-located photovoltaic (PV) solar arrays, and a battery energy storage system. The framework optimizes electric bus and battery storage operations to minimize costs and emissions with the consideration of on-site solar generation, hourly marginal grid emissions factors, and predictions of bus energy consumption through a surrogate model. We evaluate the framework in a case study of Stanford University's Marguerite Shuttle electric bus fleet for both a campus depot, whereby non-controllable loads are coupled behind-the-meter, and a stand-alone depot. In a techno-economic analysis, we find that joint optimization of a campus depot's battery storage and bus operations saves at least $1.79M USD in electricity costs over a 10-year horizon while also reducing 98% of carbon emissions associated with the depot. For a stand-alone depot, sensitivity analyses show that 100% elimination of depot emissions is achievable without any trade-off with bill savings, whereas for depots with reduced on-site solar capacity, using an emissions-aware optimization model can reduce the depot's carbon footprint by an additional 17% at a carbon abatement cost of $66/tCO2 compared to a model that only minimizes electricity costs. Furthermore, optimized bus and battery operations have even greater impact in reducing electricity costs under new net billing tariff (NBT) policies (“net energy metering (NEM) 3.0”) compared to previous NEM 2.0 policies. As adoption of electric buses continues to grow, fleet operators may leverage our flexible framework to ensure smart, low-cost, and low-emissions fleet operations.

The present invention provides a comprehensive 24/7 CFEF Platform built upon a novel digital twin framework that jointly optimizes electric bus and battery storage operations based on real data that includes hourly grid marginal emissions factors, minimization of electricity prices that considers demand charges and a NBT policy, a techno-economic analysis of co-located storage that considers its degradation, and a carbon price and solar capacity sensitivity analysis. Among the significant contributions of this platform are the following:
1. A digital twin framework of an electric bus fleet system that includes a surrogate model for electric bus energy consumption estimation and an optimization module for coordinating PV solar, battery storage, bus-block assignments, and bus charging while minimizing electricity costs and carbon emissions.
2. A demonstration of the proposed approach in realistic case studies using data from the Stanford Marguerite Shuttle transit system, which provides insight on the behavior of optimized operations.
3. A lifetime techno-economic analysis of a battery energy storage system installed at an electric bus depot, with and without fleet operation coordination.
4. Performance analyses using varying PV solar capacities, prices of carbon, electric utility tariffs, and different NEM and NBT policies.

This description is structured as follows. The Methods section introduces the digital twin framework and each of its modules. Crucially, we formally define the MILP optimization problem that determines depot operations. The Case Study section describes the data used to build the case studies, which are used to evaluate the 24/7 CFEF Platform. The Results section presents the simulation results of the platform, including a detailed study of optimal control behavior, a techno-economic analysis of the battery system, and sensitivity analyses of system performance under varying solar sizing and pricing scenarios.

### Methods

In this section, we present a digital twin framework for electric bus fleet depots with PV solar and battery storage. The desiderata driving the design of this framework include robustness to uncertainty, high model fidelity of each key depot component, and tractable decision-making capabilities for minimizing the depot's cost and emissions.

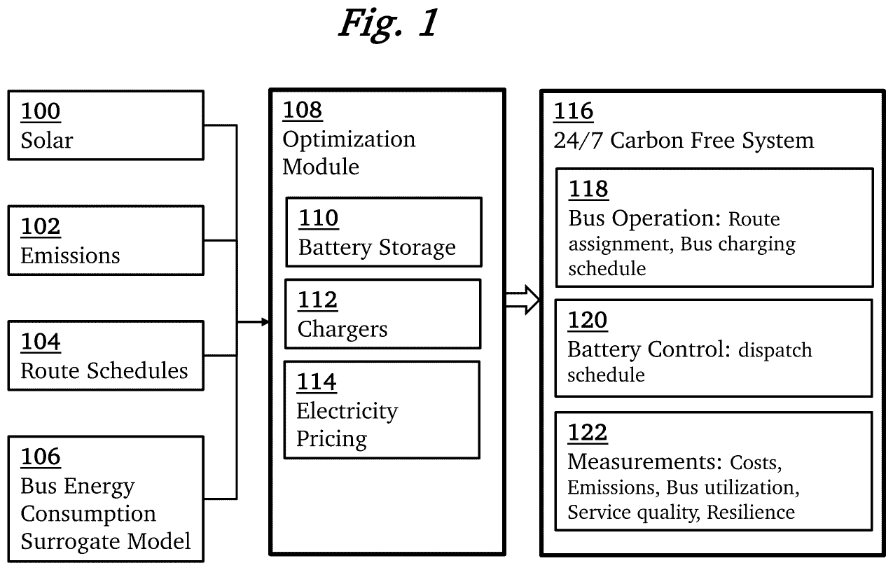

FIG. 1 is a schematic of the 24/7 CFEF Digital Twin Framework, showing the core modules of the framework and their relationships. Forecast modules 100, 102, 104 and the bus energy consumption surrogate model 106 provide inputs to the optimization module 108, which determines and outputs to a 24/7 Carbon Free System 116 bus and battery storage operations 118, 120 that minimize cost and emissions and their resulting performance metrics 122. Specific hardware used to implement the system will depend on fleet size, vehicle types, and charging station specifications. In the example case discussed below, we assume a Battery Energy Storage System (BESS) rated at 658 kWh/300 kW, approximately 40 buses with battery capacities of 180 kWh, 324 kWh, and 313 kWh, a 1.8 MW rooftop PV solar system, and 24 chargers with a charging rate of 80 kW each.

It is important to note that the system described herein can assist in designing BESS specifications and PV systems by running iterative simulations for fleets of varying sizes and configurations of buses and charging stations. The software can receive input from our optimization in real-time operational scenarios to automatically dispatch the BESS. It could also be integrated into a more advanced depot setup, with sophisticated charging stations that allow charging power to be dynamically adjusted, enabling fully automated system management.

In a preferred embodiment, forecast modules 100, 102, 104 make daily predictions of key input parameters, such as solar generation by solar module 100, grid marginal carbon emissions by emissions module 102, and weather for a one-week horizon in accordance with the weekly periodicity of bus operations module 104. A surrogate model 106 for electric buses estimates their energy consumption based on inputs from weather forecast fleet telemetry data pipelines. An optimization module 108 outputs feasible, cost-and emissions-minimizing bus fleet operations 118 and battery storage 120 for the upcoming horizon and is solved within a day in advance. The framework is applicable for bus fleets with buses designated to a single depot and assumes that blocks are pre-determined and that runcutting (assignment of drivers to the trips that constitute a block) is performed in post based on the framework's scheduling outputs. We implement this framework as a software platform in Python, using Gurobi Optimizer to solve the optimization problem.

### Forecasting

For the sake of simplicity of presentation, we will assume in this discussion perfect foresight for the forecasting modules. However, implementations in practice preferably account for uncertainties. Particular uncertain quantities that can impact the platform's performance include weather, solar generation profiles, and grid marginal emissions factors, all of which can be queried from open-source application programming interfaces (APIs). We have previously explored their performance impact when using naive forecasters. Additionally, for some depots, electricity prices and other uncontrolled loads metered with the depot may also be uncertain and require forecasts.

### Bus Energy Consumption Surrogate Model

In the bus energy consumption surrogate model 106, many factors influence the energy consumption of an electric bus, including driver behavior, weather (which can affect climate control usage and battery performance), bus occupancy, and route driven. Therefore, it is important to integrate these factors to more accurately estimate energy consumption. In a preferred embodiment, we use a Gaussian Process-based surrogate model, which is a probabilistic model that infers a distribution over data points based on known input-output values.

We assume that an output [symbol] , the bus energy consumption average for a given route in a given day, is the sum of a function f(x) and noise ε˜ [symbol] (0, σₙ²). The vector x contains features that are sources of uncertainty in bus energy consumption, including bus size (large or small), route driven, weather variables, and whether the day is a regular school day. We obtain the weather variables from the Stanford Western Weather group, including daily max, min, and average temperature (° F.), daily rain (in), daily solar radiation (cal/cm²), Heating Degree Days (HDDs), and Cooling Degree Days (CDDs). A matrix of known feature vectors, X=[x⁽¹⁾, x⁽²⁾, . . . , x^{(m)}]^{T}, is associated with a vector of average bus energy consumption values, y=[ [symbol] ⁽¹⁾, [symbol] ⁽²⁾, . . . , [symbol] ^{(m)}]^{T}, where m is the number of bus samples in the last 30 days. These samples are used to predict the values of unmapped energy consumption, ŷ, from a series of unmapped vectors, X*.

### Optimization

TABLE 1
Decision variables used in the optimization problem of Eq. (17).
All power variables are in units of kW. SoCᵢₙᵢₜ^{batt} and [SoCᵢₙᵢₜ^{b} [symbol]
can also be fixed inputs.

| Decision | | |
|---|---|---|
| variable | Domain | Description |
| [symbol] _{charge}^{batt} | {0, 1 [symbol] | Indicator for battery charging |
| [symbol] _{discharge}^{batt} | {0, 1 [symbol] | Indicator for battery discharging |
| SoC^{batt} | [symbol] | State of charge of battery |
| P^{batt} | [symbol] | Battery power |
| Pₛₒₗₐᵣ^{batt} | [symbol] | Power from solar to charge battery |
| P_{grid, charge}^{batt} | [symbol] | Power from grid to charge battery |
| P_{grid, discharge}^{batt} | [symbol] | Power from battery discharged to grid |
| P_{charger}^{batt} | [symbol] | Power from battery |
| | | discharged to charger |
| P^{charger} | [symbol] | Charger power |
| Pₛₒₗₐᵣ^{charger} | [symbol] | Power from solar to charger |
| P_{grid}^{charger} | [symbol] | Power from grid to charger |
| [symbol] ^{b} | {0, 1 [symbol] | Indicator for charging for bus b ϵ [symbol] |
| SoC^{b} | [symbol] | State of charge of bus b ϵ [symbol] |
| P^{b} | [symbol] | Power of bus b ϵ [symbol] |
| P_{charge}^{b} | [symbol] | Charging power of bus b ϵ [symbol] |
| Xₛ | {0, 1 [symbol] | Assignment matrix for buses |
| | | and blocks of type s ϵ [symbol] |
| P_{grid}^{solar} | [symbol] | Power from solar to grid |
| P^{grid} | [symbol] | Power at grid, the connection |
| | | point of depot components |
| P^{meter} | [symbol] | Power at meter |
| Pₘₐₓ^{meter} | [symbol] _{≥0}ⁿ^{_{demand charge}} | Maximum power consumed at meter |
| | | during each demand charge period |
| SoCᵢₙᵢₜ^{batt} | [0, 1] | Initial state of charge of battery |
| SoCᵢₙᵢₜ^{b} | [0, 1] | Initial state of charge of bus b ϵ [symbol] |

The optimization module 108 of the 24/7 CFEF Platform determines for a bus depot its bus-block assignments, bus charging schedules, and battery storage charging/discharging that minimize its carbon emissions and electricity bill, which is composed of electricity energy and demand charges, less the cost offsets and revenue from power injected back to the grid. Here, we refer to “grid” as the behind-the-meter common connection point of the depot's three key components: the battery storage system, the electric bus chargers, and the PV solar system.

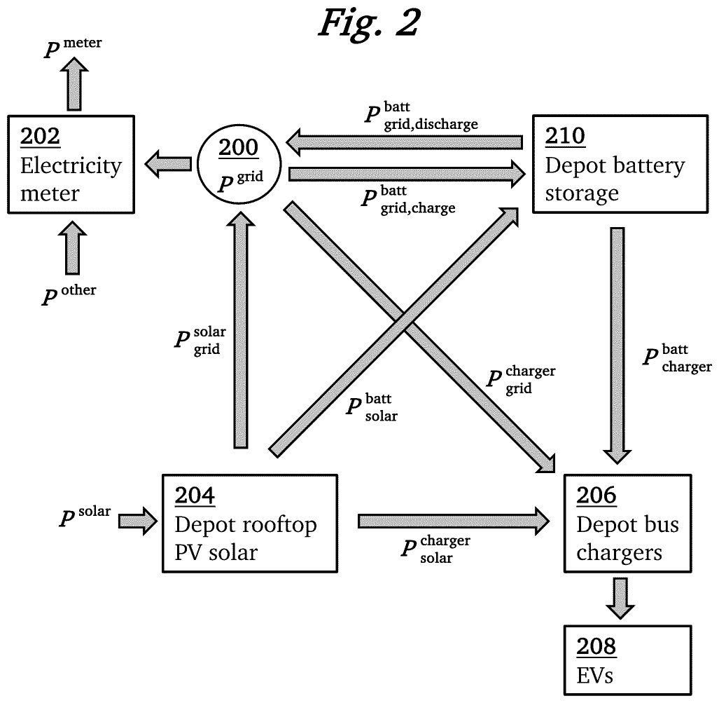

We model the optimization problem as a MILP, described in Eq. (17) with its decision variables listed in Table 1. FIG. 2 is a schematic showing the key power flow decision variables and their relationship with the system components as modeled in the optimization problem of Eq. (17). The system components include power grid 200, electricity meter 202, depot rooftop PV solar panels 204, depot vehicle chargers 206 for vehicles 208, and depot battery storage 210.

The input variables are the power P^{solar} generated by the solar panels 204, and other power P^{other}. All other labeled power flows are optimization decision variables. These variables include the power flow P_{grid,charge}^{batt} from the grid 200 to the battery 210, the power flow P_{grid,discharge}^{batt} from the battery 210 to the grid 200, the power flow P_{grid}^{solar} from the solar panels 204 to the grid 200, the power flow Pₛₒₗₐᵣ^{batt} from the solar panels 204 to the battery 210, the power flow Pₛₒₗₐᵣ^{charger} from the solar panels 204 to the charger 206, the power flow P_{grid}^{charger} from the grid 200 to the charger 206, and the power flow P_{charger}^{batt} from the battery 210 to the charger 206.

The optimization problem is solved for a horizon consisting of a set of equidistant time steps, [symbol] , of duration Δₜ in hours, for a set of heterogeneous buses [symbol] , and for operating a set of bus blocks [symbol] .

The following equations model the depot's battery energy storage system:

$$S o {C}^{b a t t} [ 1 ] = S o {C}_{i n i t}^{b a t t} \qquad ( 1 )$$

$$So {C}^{b a t t} [ 1 ] = S o {C}^{b a t t} [ \vert 𝒯 \vert ] \qquad ( 2 )$$

$$\begin{matrix}So {C}^{b a t t} [ t ] \geq S o {C}_{min}^{b a t t} & ∀ t ∈ 𝒯\end{matrix} \qquad ( 3 )$$

$$\begin{matrix}So {C}^{b a t t} [ t ] \leq S o {C}_{max}^{b a t t} & ∀ t ∈ 𝒯\end{matrix} \qquad ( 4 )$$

$$\begin{matrix}{P}^{b a t t} [ t ] = {η}_{b a t t} ( {P}_{grid , charge}^{b a t t} [ t ] + {P}_{solar}^{b a t t} [ t ] ) - \frac{1}{{η}_{b a t t}} {P}_{grid , discharge}^{b a t t} [ t ] + {P}_{c h a r g e r}^{b a t t} [ t ] & ∀ t ∈ 𝒯\end{matrix} \qquad ( 5 )$$

$$\begin{matrix}So {C}^{b a t t} [ t ] = S o {C}^{b a t t} [ t - 1 ] + \frac{{P}^{b a t t} [ t ] {Δ}_{t}}{{E}_{b a t t}} & ∀ t ∈ \{ 2 , … , \vert 𝒯 \vert \}\end{matrix} \qquad ( 6 )$$

$$\begin{matrix}{P}_{grid , charge}^{b a t t} [ t ] + {P}_{solar}^{b a t t} [ t ] \leq {y}_{c h a r g e}^{b a t t} [ t ] {\overline{P}}^{b a t t} & ∀ t ∈ 𝒯\end{matrix} \qquad ( 7 )$$

$$\begin{matrix}{P}_{grid , discharge}^{b a t t} [ t ] + {P}_{c h a r g e r}^{b a t t} [ t ] \leq {y}_{d i s c h a r g e}^{b a t t} [ t ] {\underline{P}}^{b a t t} & ∀ t ∈ 𝒯\end{matrix} \qquad ( 8 )$$

$$\begin{matrix}{y}_{c h a r g e}^{b a t t} [ t ] + {y}_{d i s c h a r g e}^{b a t t} [ t ] \leq 1 & ∀ t ∈ 𝒯\end{matrix} \qquad ( 9 )$$

Eq. (1) sets the battery state of charge (SoC) at the first time step to SoCᵢₙᵢₜ^{batt}∈[0,1], which can be a fixed input or a decision variable. Eq. (2) is the periodicity constraint, setting the SoC at the last time step equal to that of the first time step. Eq. (3) and Eq. (4) bound the SoC to maintain a desired backup power reserve or to mitigate accelerated battery degradation. Eq. (5) defines the power flow within the battery, where η_{batt} is the battery's charging/discharging efficiency. Eq. (6) defines the SoC evolution, where E_{batt} is the battery's rated energy capacity in kWh. Eq. (7) and Eq. (8) bounds the battery charging and discharging power, where P̅^{batt} and P^{batt} are the rated charging and discharging rate limits of the battery, respectively. Eq. (9) is the complementarity constraint that ensures the battery cannot simultaneously charge and discharge. The battery model assumes it can charge or discharge up to its rated power at any SoC.

The buses can park, charge, start a block, or end a block at the depot. Each bus is characterized by a type s∈ [symbol] , which is defined by its size, energy consumption, charging speed, and battery capacity. Each block r∈ [symbol] has a specified start and end time in [symbol] and a specified type s∈ [symbol] for the type of buses that operate r. Accordingly, we denote [symbol] ₛ and [symbol] ₛ as the subset of buses and subset of blocks of type s, respectively. Each bus b∈ [symbol] ₛ for every type s∈ [symbol] is modeled by the following equations:

$$S o {C}^{b} [ 1 ] = S o {C}_{i n i t}^{b} \qquad ( 10 )$$

$$So {C}^{b} [ 1 ] = S o {C}^{b} [ \vert 𝒯 \vert ] \qquad ( 11 )$$

$$\begin{matrix}So {C}^{b} [ t ] \geq S o {C}_{min}^{b} & ∀ t ∈ 𝒯\end{matrix} \qquad ( 12 )$$

$$\begin{matrix}So {C}^{b} [ t ] \leq S o {C}_{max}^{b} & ∀ t ∈ 𝒯\end{matrix} \qquad ( 13 )$$

$$\begin{matrix}{P}_{c h a r g e}^{b} [ t ] \leq {η}_{c h a r g e r} {η}_{b} min ( {\overline{P}}^{b} , {\overline{P}}^{c h a r g e r} ) & ∀ t ∈ 𝒯\end{matrix} \qquad ( 14 )$$

$$\begin{matrix}{P}^{b} [ t ] = {P}_{c h a r g e}^{b} [ t ] - {\sum }_{r ∈ {ℛ}_{s , t}} {X}_{s}^{b , r} {E}_{r , s} & ∀ t ∈ 𝒯\end{matrix} \qquad ( 15 )$$

$$\begin{matrix}So {C}^{b} [ t ] = S o {C}^{b} [ t - 1 ] + \frac{{P}^{b} [ t ] {Δ}_{t}}{{E}_{b}} & ∀ t ∈ \{ 2 , … , \vert 𝒯 \vert \}\end{matrix} \qquad ( 16 )$$

Eq. (10) sets the initial SoC of bus b, which can be a fixed input or a decision variable. Eq. (11) is the bus' SoC periodicity constraint. Eq. (12) and Eq. (13) bound the bus' SoC, used for keeping a buffer against operational uncertainties or for mitigating accelerated bus battery degradation. Eq. (14) upper bounds the charging power of the bus, where η_{charger} is the charging supply equipment's efficiency, η_{b} is the bus battery's charging efficiency, P̅^{b} is the bus battery's charging limit, and P̅^{charger} is charging station's maximum charging power. Eq. (15) determines the power flow within the bus' battery, where E_{r,s} is the energy consumed in kWh in one time step by a bus of type s completing block r, and [symbol] _{s,t} is the subset of blocks with buses of type s that are in operation at time t. E_{r,s} is predicted by the surrogate model presented in the Bus Energy Consumption Surrogate Model section. Eq. (16) is the bus' SoC evolution, where E_{batt} is the bus battery's rated energy capacity in kWh. This bus model assumes a constant charging curve (charge power is not limited by SoC), consistent with the charging telemetry data from the Marguerite Shuttle, and that the chargers and buses are capable of throttling the charging power.

Finally, the optimization problem Eq. (17) combines the above battery storage and bus modeling equations with other system decision variables and constraints and a cost-minimization objective function:

$${minimize}_{Table 1} {\sum }_{t ∈ 𝒯} {Δ}_{t} ( {P}_{g r i d}^{c h a r g e r} [ t ] + {P}_{g r i d , c h a r g e}^{b a t t} [ t ] ) \cdot ( {p}_{C {O}_{2}} C {O}_{2}^{g r i d} [ t ] + {p}_{e n e r g y} [ t ] ) \qquad ( 17 a )$$

$$+ {\sum }_{i = 1}^{{n}_{demand charge}} {P}_{max}^{m e t e r} [ i ] {p}_{d e m a n d} [ i ] \qquad ( 17 b )$$

$$- {\sum }_{t ∈ 𝒯} {Δ}_{t} ( {P}_{g r i d , d i s c h a r g e}^{b a t t} [ t ] + {P}_{g r i d}^{solar} [ t ] ) \cdot {p}_{e n e r g y} [ t ] \qquad ( 17 c )$$

$$- λ ( S o {C}^{b a t t} [ 1 ] + {\sum }_{b ∈ ℬ} S o {C}^{b} [ 1 ] ) \qquad ( 17 d )$$

subject to

Battery storage constraints, Eq. (1)-Eq. (9)

Bus constraints ∀b∈Bₛ, ∀s∈S, Eq. (10)-Eq. (16)

$$\begin{matrix}{\sum }_{b ∈ {ℬ}_{𝓈}} {X}_{𝓈}^{b , r} = 1 & ∀ r ∈ {ℛ}_{𝓈} , ∀ 𝓈 ∈ 𝒮\end{matrix} \qquad ( 17 e )$$

$$\begin{matrix}{\sum }_{r ∈ {ℛ}_{𝓈 , overlap , i}} {X}_{𝓈}^{b , r} \leq 1 & ∀ b ∈ {ℬ}_{𝓈} , & ∀ {ℛ}_{𝓈 , overlap , i} ∈ {( {ℛ}_{𝓈 , overlap , i} )}_{i ∈ I} , ∀ 𝓈 ∈ 𝒮\end{matrix} \qquad ( 17 f )$$

$$\begin{matrix}{\sum }_{r ∈ {ℛ}_{𝓈 , t}} {X}_{𝓈}^{b , r} + {y}^{b} [ t ] \leq 1 & ∀ b ∈ {ℬ}_{𝓈} , ∀ t ∈ 𝒯 , ∀ 𝓈 ∈ S\end{matrix} \qquad ( 17 g )$$

$$\begin{matrix}{\sum }_{b ∈ ℬ} {y}^{b} [ t ] \leq {n}_{c h a r g e r} & ∀ t ∈ 𝒯\end{matrix} \qquad ( 17 h )$$

$$\begin{matrix}\frac{{\sum }_{b ∈ ℬ} S o {C}^{b} [ t ] {E}_{b}}{{\sum }_{b ∈ ℬ} {E}_{b}} \geq S o {C}_{min}^{fleet} & ∀ t ∈ 𝒯\end{matrix} \qquad ( 17 i )$$

$$\begin{matrix}{P}^{c h a r g e r} [ t ] = {P}_{g r i d}^{c h a r g e r} [ t ] + {P}_{s olar}^{c h a r g e r} [ t ] + {P}_{c h a r g e r}^{b a t t} [ t ] & ∀ t ∈ 𝒯\end{matrix} \qquad ( 17 j )$$

$$\begin{matrix}{P}^{c h a r g e r} [ t ] = {\sum }_{b ∈ ℬ} \frac{{P}_{c h a r g e}^{b} [ t ]}{{η}_{c h a r g e r} {η}_{b}} & ∀ t ∈ 𝒯\end{matrix} \qquad ( 17 k )$$

$$\begin{matrix}{P}_{g r i d}^{s olar} [ t ] = {P}^{s olar} [ t ] - {P}_{s olar}^{b a t t} [ t ] - {P}_{s olar}^{c h a r g e r} [ t ] & ∀ t ∈ 𝒯\end{matrix} \qquad ( 17 l )$$

$$\begin{matrix}{P}^{m e t e r} [ t ] \leq {P}_{max}^{m e t e r} [ i ] & ∀ i ∈ \{ 1 , … , \vert {n}_{demand charge} \vert \} , ∀ t ∈ {𝒯}_{demand chargei}\end{matrix} \qquad ( 17 m )$$

$$\begin{matrix}{P}^{m e t e r} [ t ] = {P}^{g r i d} [ t ] + {P}^{o t h e r} [ t ] & ∀ t ∈ 𝒯\end{matrix} \qquad ( 17 n )$$

$$\begin{matrix}{P}^{g r i d} [ t ] = {P}_{g r i d}^{c h a r g e r} [ t ] + {P}_{g r i d , c h a r g e}^{b a t t} [ t ] - {P}_{grid , discharge}^{b a t t} [ t ] - {P}_{g r i d}^{s olar} [ t ] & ∀ t ∈ 𝒯\end{matrix} \qquad ( 17 o )$$

In the objective function, the first term, Eq. (17a), is composed of the electricity energy charges and carbon emissions cost. The energy consumed at time t by the depot loads, the bus chargers and battery storage, are multiplied by the sum of the time-of-use (TOU) energy price p_{energy}[t] ($/kWh) and the per-energy carbon price, which is the product of the per-mass carbon price p_{CO}_{₂} ($/t_{CO}_{₂}) and the marginal grid emissions factor CO₂^{grid}[t] (t_{CO}_{₂}/kWh). The second term, Eq. (17b), is the sum of the η_{demand charge} electricity demand charges, for which each demand charge i is the product of the maximum meter power consumed during that demand charge and its price, p_{demand}[i]. Note that some electric utility tariffs have multiple demand charges that each bill the maximum power for different times of day over a billing period. We denote the set of these times as [symbol] _{demand charge,i} for the index i demand charge among a total of n_{demand charge} demand charges. Here, each p_{demand}[i] has been appropriately scaled from the actual demand price in accordance with the experiment's time horizon relative to the billing period duration to represent the demand charge's amortized cost. The third term, Eq. (17c), is the revenue or mitigated cost obtained by injecting power back into the grid by the depot's power supplies, the battery storage and PV solar array, at the TOU energy price of p_{energy}. Lastly, the fourth term, Eq. (17d), is a small reward, weighted by λ, that allows the optimization problem to favor solutions with higher battery and bus initial SoCs to allow for greater operational flexibility, with negligible impact to the total objective. This term only has an effect when SoCᵢₙᵢₜ^{batt} and SoCᵢₙᵢₜ^{b}∀b∈ [symbol] are decision variables. As this term is not actual revenue, it is subtracted from the optimal objective in post-optimization. All dollar values in this paper are in USD.

In addition to the battery storage constraints and individual bus constraints, there are additional constraints characterizing bus-block assignments, bus charging, and fleet SoC. Eq. (17e) enforces that each block is assigned to exactly one bus. Eq. (17f) enforces that a bus b of type s can only operate at most one block at a given time, where I indexes all subsets [symbol] _{s,overlap,i} of blocks of type s that all share at least one time step of overlap. Eq. (17g) enforces that at a given time t a bus cannot both operate a block that is in operation at time t and charge. Eq. (17h) upper bounds the number of buses that can charge at time t by the number of charger plugs, n_{charger}. Eq. (17i) lower bounds the fleet-wide average SoC, weighted by each bus' battery capacity, to SoCₘᵢₙ^{fleet}. When SoCₘᵢₙ^{b}<SoCₘᵢₙ^{fleet}, this constraint ensures not all buses are near its minimum charge limit simultaneously, for example, in an event of a unexpected power outage. Fleet operators that do not require this bound can set SoCₘᵢₙ^{fleet}=0 or exclude this constraint.

There are also additional constraints defining power flows in the system. Eq. (17j) defines charger power supply, which can be supplied from the grid, PV solar, or battery storage. Eq. (17k) defines charger power demand, which is the sum of the charging power of the buses after accounting for losses. Eq. (171) defines the surplus PV solar generation injected to the grid P_{grid}^{solar}, where P^{solar} is the solar generated. Because the surplus solar variable P_{grid}^{solar} is non-negative, the sum of battery storage charging and bus charging load supplied by solar are constrained to not exceed the solar generated. Eq. (17m) defines the maximum net power at the electricity meter during each demand charge period i, where [symbol] _{demand charge,i} is the set of time steps in demand charge period i. The net power at the meter is defined by Eq. (17n), where positive values denote net load and negative values denote net generation. P^{grid} is the depot's net power drawn from or injected to the meter, defined by Eq. (17o). P^{other}∈ [symbol] is the sum of uncontrolled auxiliary net power at the depot and, if the depot is metered together with upstream facilities when determining the demand charge, the net power of these facilities.

The 24/7 CFEF Platform can be deployed to determine daily bus depot operations via model predictive control. Specifically, the platform solves the optimization model in Eq. (17) each day using prediction inputs from a solar forecasting module, an emissions forecasting module, and the surrogate model of the bus energy consumption to determine P^{solar}[t], CO₂^{grid}[t], and E_{r,s}∀r∈ [symbol] , ∀s∈ [symbol] , respectively. SoCᵢₙᵢₜ^{batt} and SoCᵢₙᵢₜ^{b}∀b∈ [symbol] define the system's initial state which can be updated from the current SoC measurements of the battery storage and each bus.

### Model Assumptions and Limitations

An appropriate choice of time step, Δₜ, is important in the tradeoff between model fidelity and computational tractability. A sufficiently fine-grained time resolution is required to capture depot operation dynamics, such as bus dwell time and charging duration, route schedules and their resulting bus assignments, solar and campus load power profiles, electricity pricing, and grid marginal emissions factors. On the other hand, an unnecessarily small time resolution increases the number of variables linearly, as shown in the variable descriptions in Table 1, which has a super-linear impact on solve time in general for MILP problems. In the example system discussed here, 15 minutes is preferably the largest timestep. Larger timesteps (e.g., 30 minutes or 1 hour) would not capture dwelling dynamics accurately and would prevent us from properly discretizing charging sessions and route assignments. Smaller timesteps, such as 5 minutes or 1 minute, can be used and would provide more accurate charging sessions, bus route assignments, and dwelling times. However, this would significantly increase the computational cost of solving the optimization problem.

In the case studies based on data from Stanford University's Marguerite Shuttle, we choose a 15-minute time step (i.e., Δₜ=0.25 hours). We justify this choice since the dwell times of the Marguerite Shuttle buses range from 30 minutes to many hours, the bus/driver assignments are rounded to 15-minute intervals, the power data are metered every 15-minutes, and the electricity pricing and marginal emissions factors data are determined hourly.

We also note that constraint Eq. (17m) assumes that the utility company's demand charge time interval is equal to the experiment's time interval, Δₜ. In our case studies using tarriffs of Pacific Gas and Electric Company (PG&E), this aligns with PG&E′s demand charge based on the average power over a 15-minute interval reading. If instead the choice of Δₜ was smaller than the utility's interval reading, then constraint Eq. (17m) would need to be appropriately modified so that its left hand side is Pₘₑₜₑᵣ averaged over the interval reading; this would remain a linear constraint.

A few comments are in order about the applicability of this framework's optimization model to general bus transit networks. First, the model determines bus-block assignments and bus charging schedules assuming that these buses and blocks are for a specified depot. Thus, each depot of a multi-depot fleet can use this model in parallel provided that there are no cross-depot interactions. Second, the model in its current form assumes the chargers are homogeneous in their specifications and that blocks can be operated only by buses of one particular type. Both of these assumptions can be addressed with minor modifications to the optimization problem in Eq. (17) that preserves linearity but at the cost of introducing additional binary variables and constraints.

Third, the framework does not determine the design of bus routes, the design of bus service schedules, the creation of the blocks, or runcutting (assignment of drivers to the trips that constitute a block). Routes, service schedules, and blocks are assumed to be pre-determined inputs, and runcutting is assumed to be solved after based on the framework's output.

### Considering Net Energy Metering and Net Billing Tariff Policies

The optimization model in Eq. (17) is configured for depots under a NEM policy, for which an electricity customer's import rate and export rate are equal. Under NEM, any surplus generated power P^{surplus}∈ [symbol] at time t∈ [symbol] that is injected to the meter, defined as P^{surplus}[t]=min (P^{meter}[t], 0), will be paid as revenue at the price [symbol] [t], which is the same price for which power consumed from the meter P^{consumed}∈ [symbol] , defined as P^{consumed}[t]=max(P^{meter}[t], 0), is charged.

In contrast, under a NBT, the import and export rates are not equal, and the export rate is typically the electric utility's avoided cost, which we denote as p_{NBT}∈ [symbol] ($/kWh). Note that the objective function term Eq. (17c) uses the import rate p_{energy}[t] for the power injected by pₛₒₗₐᵣ[t] and P_{grid}^{batt}[t] at time t, which may be in surplus of load. Thus, an additional correction term is needed so that surplus power at time t that was priced at p_{energy} in Eq. (17c) is reverted and instead correctly priced at the export rate P_{NBT}[t]. This can be achieved by adding the following term to the objective function of the optimization model:

$$- {\sum }_{t ∈ 𝒯} {Δ}_{t} {P}^{s urplus} [ t ] ( {p}_{e n e r g y} [ t ] - {p}_{NBT} [ t ] ) . \qquad ( 18 )$$

Surplus and consumed power are complementary; they cannot be simultaneously non-zero. This is enforced by adding the following linear constraints to the model:

$$\begin{matrix}{P}^{s urplus} [ t ] \geq ( 1 - z [ t ] ) {M}^{s urplus} [ t ] & ∀ t ∈ 𝒯\end{matrix} \qquad ( 19 )$$

$$\begin{matrix}{P}^{consumed} [ t ] \leq z [ t ] {M}^{consumed} [ t ] & ∀ t ∈ 𝒯\end{matrix} \qquad ( 20 )$$

$$\begin{matrix}{P}^{s urplus} [ t ] + {P}^{consumed} [ t ] = {P}^{m e t e r} [ t ] & ∀ t ∈ 𝒯 .\end{matrix} \qquad ( 21 )$$

Here, z∈{0, 1 [symbol] is an indicator that ensures complementarity between P^{surplus} and P^{consumed}, M^{surplus}[t] is a large negative constant that can be set to the minimum possible value of P^{meter}[t] at time t (e.g., the sum of the depot's PV solar capacity negated, the battery's maximum discharge rate negated −P^{batt}, and P^{other}[t]), and M^{consumed}[t] is a large positive constant that can be set to the maximum possible value of P^{meter}[t] (e.g., the sum of the maximum possible bus charging load n_{charger}P̅^{charger}, the battery's maximum charge rate P̅^{batt}, and P^{other}[t]).

Formally, the modified optimization problem for depots under a NBT is defined as:

$$\begin{matrix}{{minimize}_{Table 1 , z ,}}_{{P}^{surplus} , {P}^{consumed}} & Objective function of problem Eq . ( 17 ) + Eq . ( 18 )\end{matrix} \qquad ( 22 a )$$

subject to
Constraints from problem Eq. (17)

### Eq. (19)-Eq. (21)

For depots which have neither a NEM policy nor NBT, i.e., surplus energy yields no revenue, we can also employ the modified optimization problem Eq. (22) with the special case of setting p_{NBT}[t]=0 ∀t∈ [symbol] in Eq. (18).

### Case Studies

In this section, we outline case studies to evaluate the 24/7 CFEF Platform built on the framework described in the Methods section by using real data collected from the bus depot of Stanford University's Marguerite Shuttle, which serves approximately 15 publicly open routes on and off campus and has an annual ridership of over 2.74 million. Digital twin data pipeline inputs include (i) bus telemetry, which includes average energy consumption for buses of a given size along each route, (ii) generation profiles of the PV solar array located at the Marguerite bus depot, (iii) the California Independent System Operator (CAISO) marginal grid emissions factors, (iv) weather-related features, (v) Marguerite Shuttle schedules and Stanford academic calendar data, and (vi) electricity prices.

### Electric Buses

The Marguerite Shuttle fleet includes three electric bus models, BYD K7, K9, and K9M, with battery capacities E_{b} of 180 kWh, 324 kWh, and 313 kWh, respectively. The K7 buses are of type s=small whereas K9 and K9M buses are of type s=large. Their SoC bounds are set to SoCₘᵢₙ^{b}=0.2 and SoCₘₐₓ^{b}=1.0, consistent with the practice of Marguerite operators. We set their AC charging efficiency to η_{b}=0.9. When not serving a route, the buses will return to the depot, which has η_{charger}=24 chargers rated at P̅_{charger}=80 kW AC with an efficiency of η_{charger}=0.95. From the charging data collected, we observe charging power to be constant and independent of SoC. This is because the charging rate of the EV supply equipment is much lower than the maximum charging rate of the buses' batteries, so the constant current and constant voltage modes consume equal power.

### Bus Blocks

Most of the Marguerite routes operated by electric buses have commute schedules, with services during the morning and evening weekday commute cycles and a midday break. However, there are also five routes with all-day service on weekdays, one route with service only on Fridays and weekends, and one route with late evening service weekdays. Each Marguerite route is divided into scheduled blocks that fleet operators assign to specific buses. A block begins at the bus depot, completes a specified number of loops of a given route, and ends at the bus depot. This study considers 38 electric buses serving Marguerite routes that are divided into 255 blocks per week in January-April, 256 blocks per week in July-September, and 261 blocks per week in May-June and October-December. Operators assign each block a type s∈{small, large} based on the power, seating capacity, and turning radius of the bus required to operate that block. We use a fleet average minimum SoC of Socₘᵢₙ^{fleet}=0.5 based on the preferences of Marguerite operators, who have requested an ample buffer against potential operational uncertainties (e.g., drivers not adhering to schedules, weather impacts, and failures with charging equipment) and the ability to sustain shuttle services in the event of a power outage.

### Bus Energy Consumption and Baseline Charging

We use bus assignment and charging data collected from the Marguerite in 2022-2023 to build the surrogate model described in the Bus Energy Consumption Surrogate Model section. The charging data is also the basis of our baseline scenarios, which we use to benchmark the performance of the platform. In the status quo, the Marguerite Shuttle bus operators typically charge the buses at the end of blocks whenever the buses return to the depot, which results in moderate charging activity after the morning weekday commute buses return and the greatest charging activity after the evening weekday commute buses and all-day service buses return.

### Battery Energy Storage System

We define the parameters of the battery model based on the specifications of the battery energy storage system planned for installation at the Marguerite Shuttle depot. It has a capacity of E_{batt}=658 kWh, a maximum charge/discharge rate of P̅_{batt}=300 kW, efficiency of η_{batt}=0.95, minimum SoC limit of SoCₘᵢₙ^{batt}=0.2, and maximum SoC limit of SoCₘₐₓ^{batt}=1.0. In the baseline scenario, there is no battery storage system.

### PV Solar System

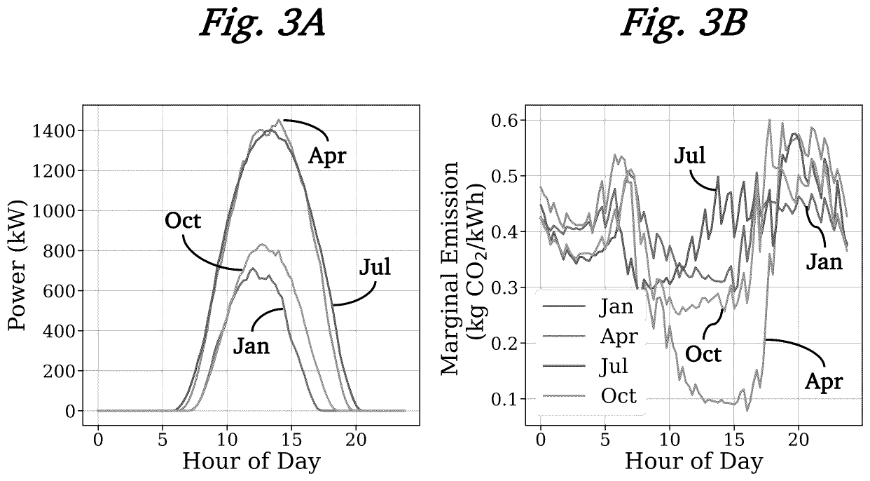

We forecast Pₛₒₗₐᵣ based on the generation data collected from the 1.8 MW rooftop PV solar array located at Marguerite Shuttle depot, which provides carbon-free electricity to the bus chargers and battery storage. FIG. 3A depicts the average daily solar generation at this depot for January, April, July, and October 2023, with daily peak generation ranging from an average of 700 kW in the winter to 1400 kW in the summer.

### Marginal Emissions Factors

To calculate carbon emissions associated with the depot's net power draw from the grid and account for the time-varying carbon intensity of electricity, we use marginal emissions factors determined by CAISO for the PG&E default load aggregation point (DLAP) where Stanford University is located. FIG. 3B depicts the average marginal emissions for January, April, July, and October 2023. Due to the high penetration of solar generation on the California grid, the marginal emissions factor is lowest during the midday and highest in the evening as fossil-fuel generators ramp up. To integrate the depot's associated emissions with the cost minimization objective, we use a time-varying carbon price per kWh calculated as the product of a constant carbon price per tCO₂, p_{CO}_{₂}, and the time-varying marginal emissions factor, CO₂^{grid}[t]. For institutions with sustainability goals, this carbon price enables emissions-conscious depot operations. However, institutions or depot operators will not actually incur the resulting carbon cost in the absence of a carbon tax. Accordingly, in following discussion, electricity bill does not include the carbon emissions cost term. In the main case study, we set p_{CO}_{₂}=$185/tCO₂, the mean social cost of carbon estimate.

### Electricity Pricing

The depot's electricity bill depends on several electricity prices: energy charges (costs for energy consumed), demand charges (costs for the peak power drawn in the billing month), and revenue for power injected back to the electricity meter. Price factors include the selected electric utility tariff, temporal price variations, whether the utility or another provider supplies generation services (e.g, via direct access or a community choice aggregator), and whether any NEM or NBT policies are in effect. Furthermore, whether the depot is metered with upstream facilities (e.g., a university or corporate campus) or is on its own meter (i.e., submetered or a stand-alone depot) impacts the calculation of demand charges and revenue power injections back to the meter.

In the following two subsections, we describe the electricity pricing used to examine two case studies: a campus electric bus depot that is metered with the other campus facilities, and a stand-alone electric bus depot.

### Campus Electric Bus Depot

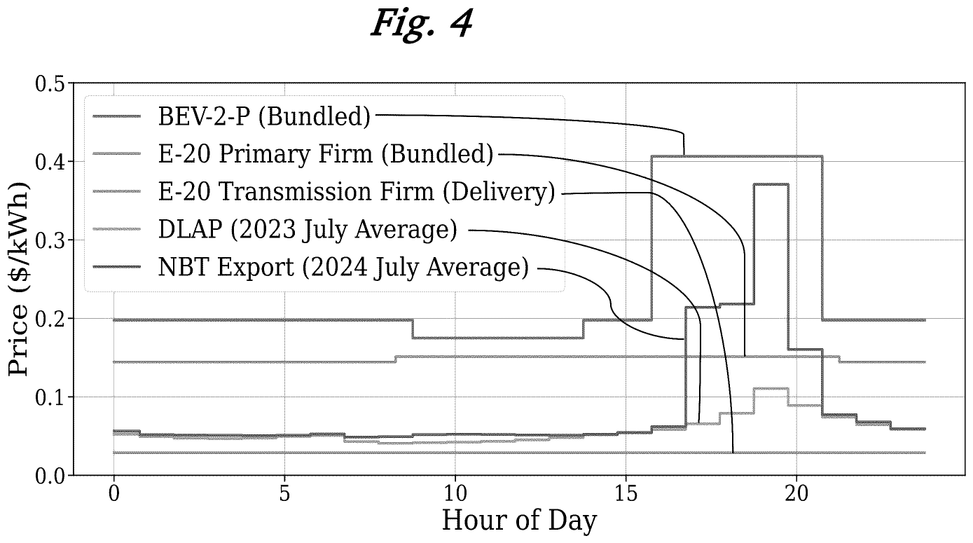

We use Stanford campus' electricity pricing for this case study wherein a campus electric bus depot is metered with the rest of the campus. For generation services, as typical for large customers that connect at the transmission grid, Stanford pays for direct access at PG&E DLAP prices determined by CAISO. For delivery services, Stanford pays for the charges outlined in the PG&E E-20 Transmission Firm tariff, which includes a fixed energy charge rate and one demand charge period (i.e., n_{demand charge}=1) with a rate of $19.68/kW applicable at all times. As the bus depot is metered with the campus, to model the demand charge, we set P^{other} in Eq. (17m) to Stanford University's net power from all of its campus facilities excluding the depot. The DLAP prices and E-20 Transmission Firm energy charge rates (2023) are shown in FIG. 4. As the campus is a large transmission-level customer, the E-20 Transmission Firm and DLAP prices used in the campus depot study are lower than the BEV-2-P and E-20 Primary Firm prices used in the stand-alone depot study. The DLAP prices, BEV-2-P prices, and NBT export prices have the greatest relative daily price variability, with higher prices in the evening.

We use the optimization problem in Eq. (17) for this case study with a one-week horizon. At Stanford University, the depot's upstream net power pother is always positive and greater than the maximum power that could be generated by the depot, therefore there is no power being exported (i.e., P^{surplus}[t]=0 ∀t∈ [symbol] ). Therefore, the modified optimization problem defined in Eq. (22) for NBT is unnecessary, as net metering is irrelevant.

### Stand-Alone Electric Bus Depot

Electric bus depots that are submetered or stand-alone are a smaller-scale customer relative to the campus-connected depot discussed above. Smaller commercial customers typically connect at the primary distribution grid and pay for bundled generation and delivery services from their electric utility with tariffs such as PG&E E-20 Primary Firm and PG&E Business Electric Vehicles Primary Voltage (BEV-2-P) used in this case study.

For this case study, we use the optimization problem in Eq. (22) with a one-week horizon. With no upstream facilities sharing the depot's meter, we set P^{other}[t]=0 ∀t∈ [symbol] and assume energy surplus is credited under a NBT policy using 2024 PG&E NBT prices. The energy charge rates of E-20 Primary Firm and BEV-2-P (2024), and the NBT prices, are also shown in FIG. 4.

### Results

In this section, we evaluate the 24/7 CFEF Platform on the case studies described above and present the resulting simulated bus depot operations and metrics for optimized and baseline scenarios, first for the campus electric bus depot study, then for the stand-alone electric bus depot study.

### Campus Electric Bus Depot

For the study of a campus electric bus depot, we first present below how optimal coordination of the bus fleet and battery storage can achieve a $2,618-$4,906 per week reduction in electricity bill and 91%-99% reductions in associated carbon emissions compared to an uncontrolled baseline. Next, we evaluate how these benefits are impacted when the platform is limited to only controlling bus operations without any battery storage at the depot or only controlling battery operations without controlling bus operations. Last, we perform a techno-economic analysis of the battery storage, with and without joint control of bus operations, over a 10-year period while accounting for battery degradation.

### Optimal Control Behavior for a Campus Electric Bus Depot

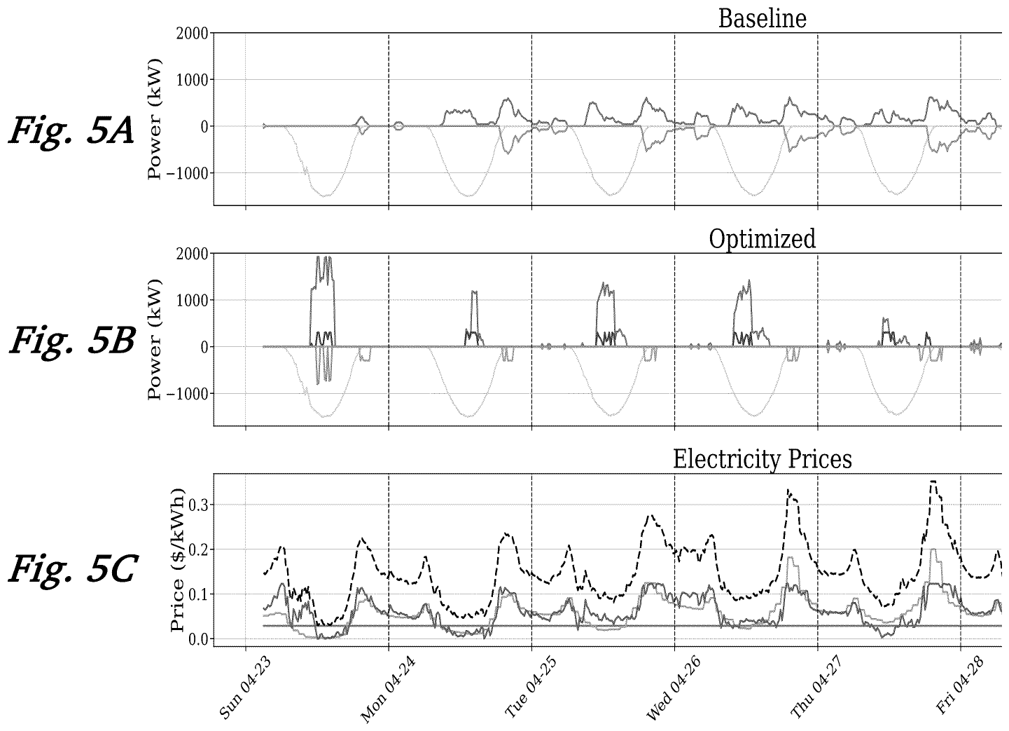

The optimized bus-block assignments, bus charging scheduling, and battery operations result in a concentration of midday bus charging when the depot's PV solar generation is greatest and electricity prices and marginal carbon emissions factors are lowest. FIGS. 5A, 5B, 5C show, respectively, each power demand and supply component of the bus depot for the baseline and optimized scenarios, as well as the electricity price, for a spring season week. In the baseline scenario, 57% of bus charging occurs in the weekday evenings after the depot's PV solar array is no longer generating power. This results in power drawn from the grid at a time when electricity prices and emissions factors are greatest. In contrast, in the optimized scenario, bus charging occurs 99% during the midday, powered by carbon-free electricity from the solar array. Optimized charging also distributes some charging load to the weekend, enabled by the choice of a one-week optimization horizon. The small amounts of bus charging demand that is drawn from the grid only occurs when the marginal emissions factors are near zero and electricity prices are low: for example, in the afternoon of April 23.

The optimized battery storage also charges during the low price and emission period in the midday, then discharges power in the early evening to offset the campus' power consumption at the most expensive price. Furthermore, in the late night, the battery discharges power to the bus chargers to recharge returning night buses with carbon-free electricity.

To reduce the campus' demand charge, which occurs on April 27 at 5:15 PM in the April billing month, the battery system discharges at this time to shave the peak demand. Additionally, unlike the baseline, no bus charging occurs at this time in the optimized scenario to avoid contributing to the demand charge.

Overall, bus and battery joint optimization reduced electricity costs by $3,680, campus peak demand by 420 kW, and emissions by 99% for this spring week. The results observed in all seasons are summarized in the “Bus +Batt” (i.e., both bus and battery operations are optimized) rows of Table 2, solved in an average compute time of 2.2 hours. Despite reduced solar generation and higher marginal emissions factors in the winter, a 91% reduction in emissions is still achieved. Seasonal variation in electricity bill savings will now be discussed.

### Limiting Control to Only Battery Storage Operations or Bus Fleet Operations

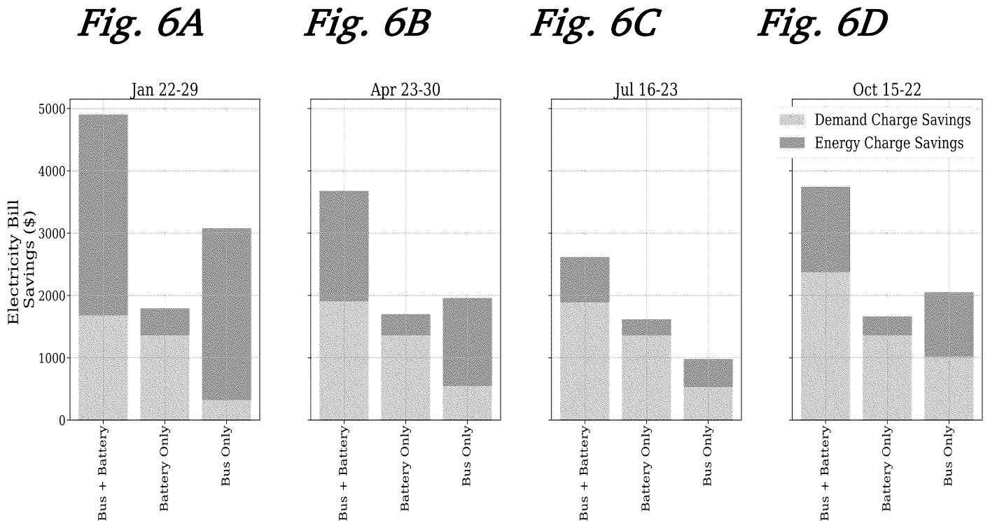

As full control over bus fleet operations or installing a battery storage system may not be viable options for every bus depot, we compare the benefits when optimal control is limited to only one component. The electricity bill and emissions reductions relative to baseline under varying optimal control schemes are tabulated in Table 2. “Battery Only” refers to a scenario where a battery is installed and its operations are optimized, but bus operations are not optimized (i.e., same as baseline). “Bus Only” refers to a scenario where there is no battery installed but bus operations are optimized. FIGS. 6A, 6B, 6C, 6D compare the electricity bill savings between each control scenario across four seasons of 2023. Battery only

TABLE 2
Summary of results for the optimized campus electric bus depot scenario. Savings
and reductions are relative to the baseline scenario. Note that the demand charge savings
shown for each week is an amortized demand charge saving of its corresponding billing month.

| | | Energy | Demand | | | Electricity |
|---|---|---|---|---|---|---|
| | | Charge | Charge | Emissions | Emissions | Bill |
| | | Savings | Savings | Reduction | Reduction | Savings |
| Case | Week | ($) | ($) | (tCO₂) | (%) | ($) |
| Bus + Batt | Jan | 3228.79 | 1677.01 | 5.96 | 91.35 | 4905.80 |
| | 22-29 | | | | | |
| Batt only | Jan | 437.34 | 1357.83 | 1.39 | 21.29 | 1795.17 |
| | 22-29 | | | | | |
| Bus only | Jan | 2760.55 | 319.18 | 6.09 | 93.29 | 3079.73 |
| | 22-29 | | | | | |
| Bus + Batt | Apr | 1776.84 | 1902.66 | 6.82 | 99.02 | 3679.50 |
| | 23-30 | | | | | |
| Batt only | Apr | 343.97 | 1357.83 | 1.7 | 24.88 | 1701.80 |
| | 23-30 | | | | | |
| Bus only | Apr | 1415.06 | 544.83 | 6.75 | 97.90 | 1959.89 |
| | 23-30 | | | | | |
| Bus + Batt | Jul | 731.99 | 1885.75 | 5.66 | 98.16 | 2617.74 |
| | 16-23 | | | | | |
| Batt only | Jul | 261.03 | 1357.83 | 1.79 | 31.08 | 1618.86 |
| | 16-23 | | | | | |
| Bus only | Jul | 450.14 | 527.92 | 5.60 | 97.15 | 978.06 |
| | 16-23 | | | | | |
| Bus + Batt | Oct | 1374.28 | 2371.83 | 6.96 | 98.35 | 3746.11 |
| | 15-22 | | | | | |
| Batt only | Oct | 305.86 | 1357.83 | 1.81 | 25.59 | 1663.69 |
| | 15-22 | | | | | |
| Bus only | Oct | 1040.08 | 1014.01 | 6.91 | 97.62 | 2054.09 |
| | 15-22 | | | | | |

control provides more demand charge savings, whereas bus only control provides more energy charge savings. As the bill savings from battery control and bus control are complementary when the depot is metered with campus, the savings are additive under joint control. Bus control is more seasonal due to variability in the interaction of electricity pricing and baseline bus charging. according to an embodiment of the invention. We note that in this case study where the depot is metered with the campus, there is always a large campus load from which to shave the peak demand charge and offset energy charges. Thus, bus and battery savings are complementary and do not compete; the savings achieved under individual control are approximately additive with respect to the savings achieved under joint control.

Demand charge savings represent 80% of total electricity bill savings for battery only control and 30% for bus only control. The battery only control's demand charge saving is constant throughout the year as it always discharges at its maximum rate during the campus' peak demand to save $1,358 per week (amortized). In contrast, the bus only control's demand charge savings depend on how much bus charging in the baseline coincides with the campus' peak demand, and how much of this on-peak charging it is able to shift, which varies month to month. In these four weeks, the bus only control was able to shift all of its on-peak charging to other times of day, achieving an average demand charge savings of $601 per week, less than half of what is saved by battery only control.

However, as the amount of energy from bus charging is greater than the battery storage's energy capacity, bus charging has more potential for reducing energy charges, despite having more constraints on its charging. Bus only control achieved an average of $1,233 saved in energy charges per week, whereas battery only control achieved only a quarter of the savings ($337 per week). Both control scenarios experienced seasonal variability in energy charge savings due to seasonality of DLAP prices. For example, the prices and price spreads were greater in January 2023, resulting in greater savings in that week. For bus only control, the amount of bus charging in the baseline that occurs during high electricity prices adds further variability to its savings potential.

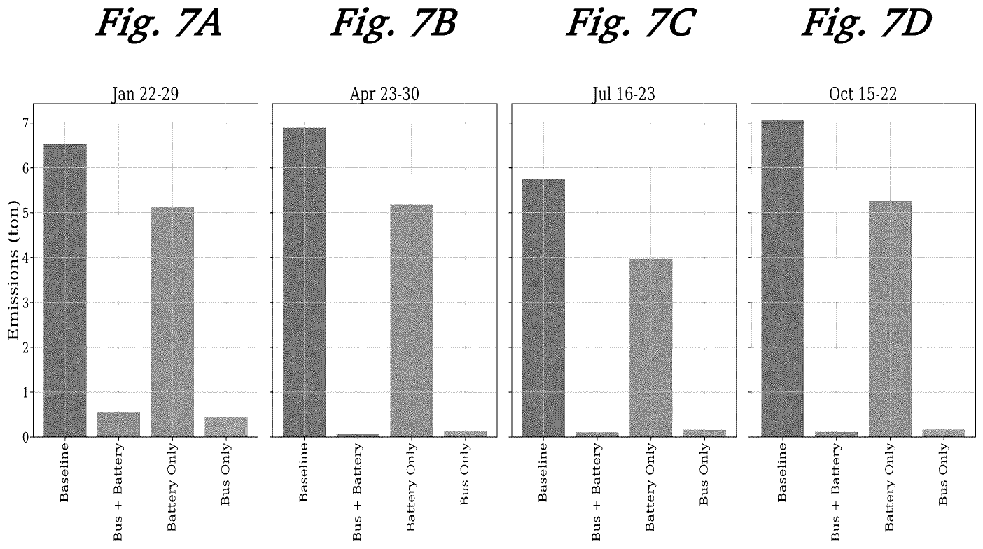

FIGS. 7A, 7B, 7C, 7D show a comparison of emissions associated with the campus depot's energy consumption between the baseline and three control scenarios over a week in four seasons in 2023. In terms of carbon emissions associated with the depot, bus control achieves most of the emissions reduction. Battery only control can reduce emissions by 25% on average. However, adding battery control to bus control adds very marginal value to emissions reduction. This is because in the battery only case, the battery is constrained by its capacity and can only provide a limited amount of carbon-free electricity to buses that may otherwise charge with carbon-intensive electricity (e.g., buses charging from the grid in the evening). In contrast, under bus only control, much of the bus charging can be shifted from the evening to the midday when the depot's PV solar is generating power, thereby eliminating 96% of the depot's associated emissions on average.

In summary, battery control yields greater reductions in demand charges whereas bus control yields greater reductions in energy charges and emissions. Joint control of bus fleet and battery operations yields additive electricity bill savings but negligible additional emissions benefits compared to bus only control.

### Techno-Economic Analysis: 10-Year Horizon With Price Changes and Battery Degradation

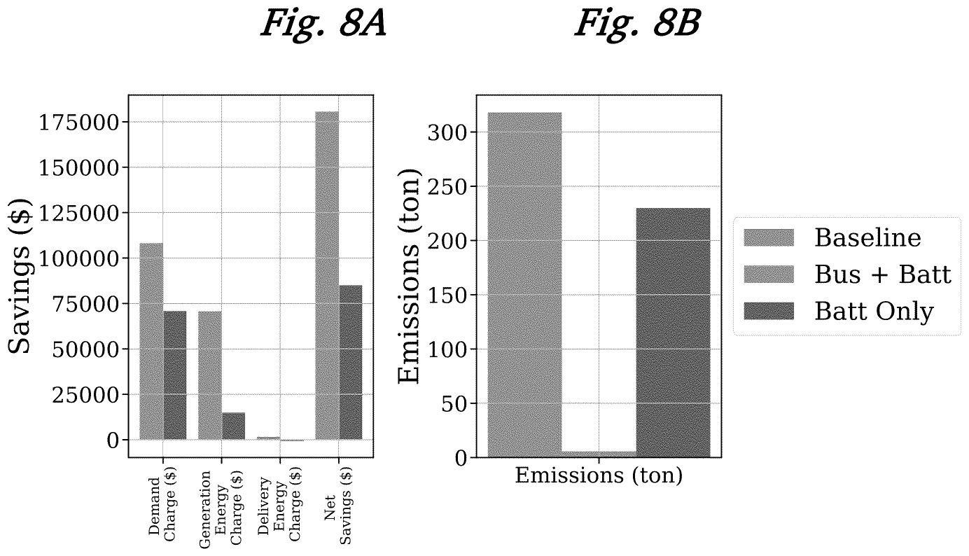

To provide a more complete quantification of the battery storage's value proposition, we optimize its operations, with and without bus coordination, for all 12 months of 2023. FIGS. 8A, 8B show this full-year analysis of an optimized campus depot: annual electricity bill savings relative to baseline (FIG. 8A) and annual carbon emissions associated with depot energy consumption (FIG. 8B). Battery only control primarily reduces demand charges, whereas joint control of bus and battery operations also considerably reduces generation energy charges and nearly eliminate emissions. according to an embodiment of the invention.

Consistent with the results described earlier, the demand charge is the most significant savings component when considering battery only control ($70,848 annual savings, representing 83% of battery only control total savings), with a moderate improvement when also including bus fleet control ($108,215). Similarly, battery only control yields modest generation energy charge savings ($14,894) and emissions reduction (88 tCO₂, a 28% reduction from baseline emissions), but including bus fleet control improves both metrics greatly ($70,731 savings and 312 tCO₂ reduction). The lack of price spread in the delivery energy rates leads to insignificant delivery energy charge savings because of roundtrip losses incurred from charging and discharging the battery storage.

Year-round, the jointly optimized bus fleet and battery operations reduce emissions by 98%, from 318 tCO₂ baseline emissions to 312 tCO₂, and lowers the electricity bill by $180,657, an average of $15,055 savings per month.

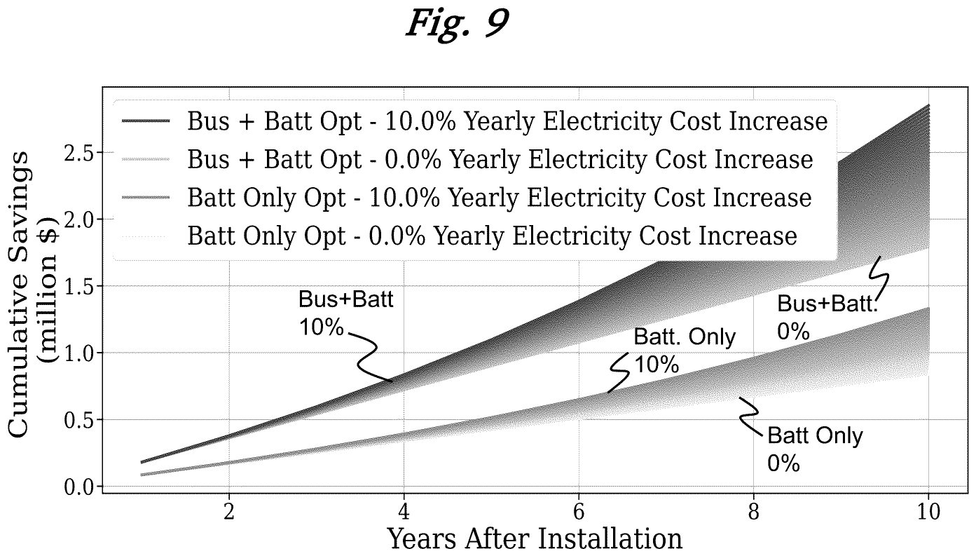

We extend this techno-economic analysis of the battery storage system over its 10-year warrantied lifetime. From the specifications sheet of the battery to be installed at the Marguerite Shuttle depot, degradation can be modeled as linear at about 2% per year, reaching 80% of its original capacity after 10 years. Our evaluations find that degradation does not affect the battery's demand charge savings potential. For battery only control, the same $70,848 in demand charge savings is observed at both 100% and 80% capacity. However, energy charge savings are approximately proportionally reduced by the amount of degradation. For battery only control, $14,193 energy charge savings is observed at 100% capacity vs. $11,148 at 80% capacity. In FIG. 9, we also consider how increasing electricity rates in California increases the annual bill savings over time. The figure shows cumulative savings from joint optimal control of bus and battery operations compared to battery only control, over a ten-year horizon. We assume an energy price increase ranging between 0% and 10% annually.

Note that the cumulative savings shown do not account for discounting by an interest rate. For an annual electricity price growth rate ranging from 0% to 10%, the value provided by the battery after 10 years ranges from $0.84 M to $1.33 M with battery only control and $1.79 M to $2.85 M with bus and battery control. The emissions reduced over 10 years are 25% for battery only control and 98% for bus and battery control.

Using $1845/kW total capital expenditures (CAPEX) and $19/kW-year fixed operation and maintenance expenses (FOM) for commercial rooftop PV solar, and $2030/kW total CAPEX and $49/kW-year FOM for commercial battery storage, the 10-year average annual return on investment is 16.05% for new solar and battery installations at a depot utilizing jointly optimized bus and battery operations compared to a baseline with no solar, no battery, and no optimization platform. This calculation assumes the CAPEX is rescaled for 10 years relative to the resource's lifetime, a 30-year lifetime for the solar system, a 15-year lifetime for the battery system, a 0% annual electricity price growth rate (i.e., no annual increase in electricity cost savings), and no monetary value contributed by achieving a 99% reduction in emissions. The CAPEX, FOM, and lifetime values are obtained from NREL (2024) using 2023 moderate scenario values and 2-hour battery storage.

The battery energy storage system could also provide resiliency benefits, since when coupled with a grid-forming inverter, it can charge buses with the PV solar generation during power outages. In this scenario, we could add avoided ownership costs of backup diesel buses or generators to the value stack, but we leave experiments with power outage scenarios and the quantification of resiliency benefits for future work.

### Stand-Alone Electric Bus Depot

For the study of a stand-alone electric bus depot, we present below how optimal coordination of the bus fleet and battery differs from that of the campus-connected case study to achieve $3,612-$4,010 per week reduction in electricity bill and 24/7 carbon-free operations (100% elimination of associated carbon emissions) compared to an uncontrolled baseline. Following, we evaluate below how varying the carbon price, electricity tariff choice, and NEM or NBT policy impact the electricity bill and carbon emissions reductions.

### Optimal Control Behavior for a Stand-Alone Electric Bus Depot

In the stand-alone depot case study, we price electricity according to the PG&E BEV-2-P tariff that is designed specifically for customers with predominantly business EV charging load. BEV-2-P features a very low demand charge rate ($1.71/kW on average) but much higher TOU energy charge rates, shown in FIG. 4, as compared to the campus depot's rates. In particular, BEV-2-P features three different energy charge rates with a significant $0.23/kWh price spread between its super-off-peak rate and its peak rate, which is 132% greater. The resulting electricity costs and carbon emissions for optimized and baseline scenarios are tabulated in Table 3 for a winter and summer week, achieved in an average compute time of 8 hours.

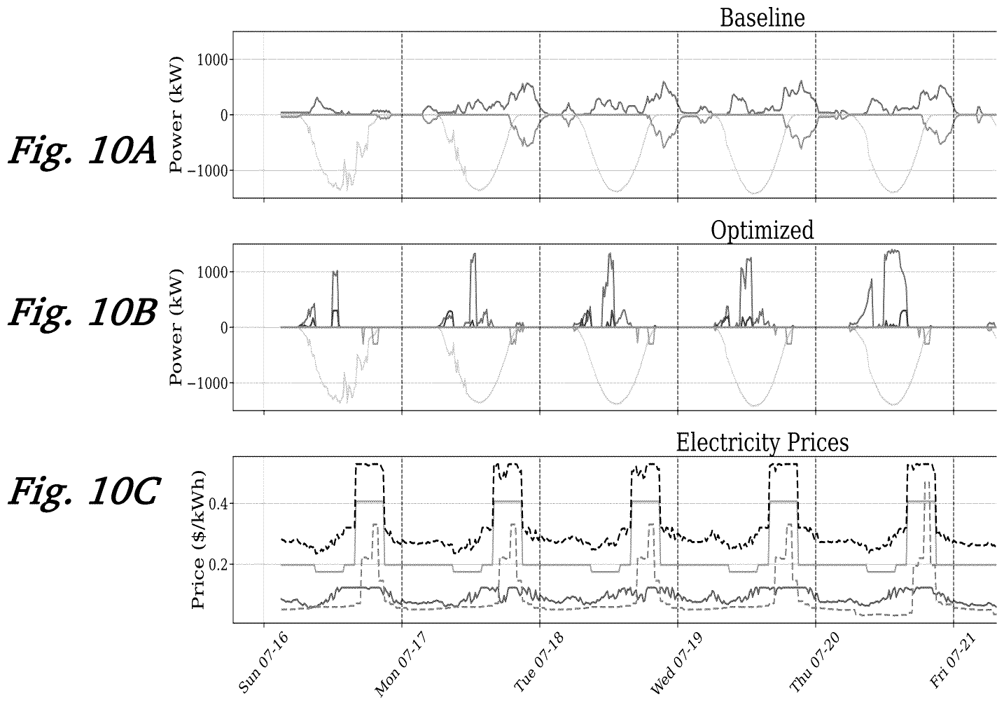

As shown in FIGS. 10A, 10B, 10C for the summer week, the optimized bus and battery operations for the stand-alone depot shares some similarities to that of the campus depot, discussed earlier. The figures show, for stand-alone depot with a NBT policy, power demand (positive) and supply (negative) at the depot for the baseline and optimized scenarios (FIG. 10A and FIG. 10B, respectively); electricity energy prices for that week, with the black plot line showing the summed total rate used to determine costs and the grey line showing the NBT export rate used to determine revenue (FIG. 10C).

Under a NBT policy for the stand-alone depot, the best export rate occurs during a short period in the evening which the battery takes advantage of to sell power back to the grid; this is similar to campus depot's battery discharging during the higher evening DLAP prices to offset the campus' energy costs. Bus and battery charging are avoided from 4 PM to 9 PM due to the diminishing solar generation and the peak price TOU period; this is similar to the campus depot's optimized load that avoids typically higher DLAP prices in the evening, however, the stand-alone depot exhibits a sharper charging cutoff at 4 PM due to the fixed schedule of TOU prices.

While the campus depot's demand charge is dictated by the larger campus' peak load during which the depot should assist the campus with peak shaving, the stand-alone depot instead must levelize its grid power consumption at all times. Optimized by the platform, the stand-alone depot is able to avoid charging from the grid entirely to achieve a $0 demand charge, which contrasts with the campus depot optimization that would at times draw grid power (provided it was not during the campus' peak demand). Also in contrast, energy charge savings are much more significant than demand charge savings for the stand-alone depot, as expected from the structure of the BEV-2-P tariff compared to the E-20 Transmission Firm tariff and DLAP prices used by the campus depot.

### Computational Tractability

For the 24/7 CFEF Platform to be able to provide optimal schedules for daily operations, its ability to meet a day-ahead compute time constraint is paramount. Using an 8-core CPU compute cluster with 16 GB RAM, the platform determined optimal schedules in an average of 646 seconds (11 minutes) for winter and summer stand-alone depot experiments using a shorter one-day horizon (38 buses, 51 blocks), reducing electricity costs by an average of $564 and emissions by 1 tCO₂ (73% reduction) per weekday. In the interest of testing scalability for large-scale public transit bus systems, we evaluated performance and compute time for the stand-alone depot case study scaled up by a factor of five. For a depot with 190 buses providing transit service through 255 daily blocks, the platform's final solution reduces the depot's electricity costs by an average of $2,804 and emissions by 5 tCO₂ (72% reduction) per weekday, solved in an average of 20.3 hours. As previously discussed, using a one-week optimization horizon improves performance by distributing charging load to the weekend, although at a tradeoff to problem size and compute time. To further improve runtime, and thereby also improving performance under a day-ahead time constraint, methods to speed up compute such as warm-starting the MILP, solver parameter tuning, and code optimization will be explored in future work.

### Sensitivity Analysis of Key Parameters

### Price of Carbon and PV Solar Capacity

While we have used in the preceding experiments a carbon price of p_{CO}_{₂}=$185/tCO₂ based on the mean estimate of the social cost of carbon, the institutions that own or operate an electric bus depot may have differing values for mitigating carbon. Motivated by this, we analyze how varying the carbon price used in the optimization's objective function impacts

TABLE 3
Summary of results for the optimized stand-alone depot scenario as discussed above
in relation to optimal control behavior for a stand-alone electric bus depot. Note that the
demand charge shown for each week is an amortized demand charge of its corresponding
billing month.

| | | Energy | Demand | Emissions | Emissions | Electricity |
|---|---|---|---|---|---|---|
| | | Charge | Charge | Reduction | Reduction | Bill |
| Case | Week | ($) | ($) | (tCO₂) | (%) | ($) |
| Baseline | Jan | 2575.41 | 294.37 | — | 0 | 2869.78 |
| | 22-29 | | | | | |
| Bus + Batt | Jan | −1139.86 | 0.00 | 6.53 | 100 | −1139.86 |
| | 22-29 | | | | | |
| Baseline | Jul | −1992.21 | 242.48 | — | 0 | −1749.73 |
| | 16-23 | | | | | |
| Bus + Batt | Jul | −5362.03 | 0.00 | 5.76 | 100 | −5362.03 |
| | 16-23 | | | | | |

the depot's electricity bill and emissions. Additional carbon prices analyzed are $0/tCO₂ (i.e., carbon emissions are no longer considered in the objective, only the electricity bill), $44/tCO₂ (5% quantile of the mean estimate of the social cost of carbon), $413/tCO₂ (95% quantile), and $805/tCO₂ (upper 66% confidence interval value for the global social cost of carbon). To also evaluate the impact of solar sizing on the platform's performance, we also vary on-site PV solar capacities as 0%, 25%, 50%, and 100% of the 1.8 MW installed capacity at the Marguerite depot that was used in the preceding experiments.

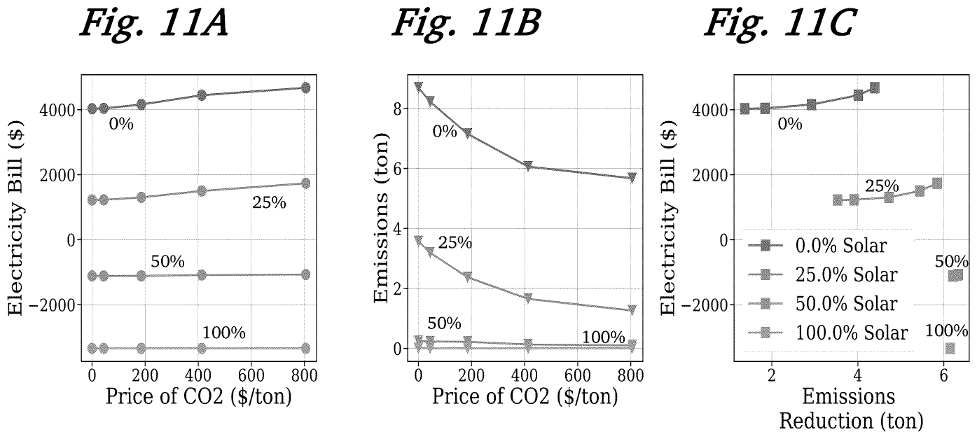

The results are shown in FIGS. 11A, 11B, 11C which are graphs of averaged optimization results for winter (January) and summer (July) with varying carbon prices and solar capacities. The graphs show electricity bill vs. carbon price (FIG. 11A), emissions vs. carbon price (FIG. 11B), and electricity bill vs. emissions (FIG. 11C). Depots with sufficient solar reduce electricity bill and emissions without sensitivity to the carbon price. For depots with reduced solar, emissions can be further reduced with increasing carbon prices, initially with a small tradeoff to electricity bill savings. However, the tradeoff becomes large at higher carbon prices.

We note that for the 50% and 100% solar cases, the electricity bill and emissions have little to no sensitivity to the carbon pricing of grid power. Specifically, when optimized operations can already completely eliminate emissions (100% solar case) or nearly eliminate emissions (50% solar case) with a $0/tCO₂ carbon price, increasing the price of carbon has little to no effect. Notably, even with 50% of the solar capacity, the platform's coordination grants 6.21 tCO₂/week reductions (96% reduction) and $3759/week cost savings relative to its 50% solar baseline without any regard to grid emission factors. This reflects how self-consumption of on-site solar is the primary means to reduce electricity costs and emissions, even without emissions in the objective function.

TABLE 4
Summary of results for a stand-alone depot with 25% solar
capacity for varying carbon prices as discussed above in
relation to sensitivity analysis of key parameters.

| | | | | Carbon abatement |
|---|---|---|---|---|
| | | | | cost relative |
| Carbon | | | Emissions | to $0/tCO₂ |
| Price | Electricity | Emissions | reduction | carbon price case |
| ($/tCO₂) | Bill ($) | (tCO₂) | (%) | ($/tCO₂) |
| 0 | 1,222.84 | 3.57 | 50 | — |
| 44 | 1,227.43 | 3.19 | 55 | 12.08 |
| 185 | 1,302.02 | 2.37 | 67 | 65.98 |
| 413 | 1,500.50 | 1.65 | 77 | 144.61 |
| 805 | 1735.89 | 1.26 | 82 | 222.10 |
| Baseline: | 3,881.08 | 7.10 | — | — |

However, for the 25% and 0% solar cases where not all emissions are eliminated, the electricity bill (which does not include carbon costs) increases approximately linearly with the carbon price whereas the emissions decrease with price but with diminishing reductions at higher prices. For example, as shown in Table 4 and FIG. 11C for the 25% solar case, having no carbon cost reduces emissions by 3.5 tCO₂ (50%) from the baseline, then introducing a moderate carbon price yields a 4.7 tCO₂ reduction (additional +17%) at a $65.98/tCO₂ carbon abatement cost, but achieving a 5.8 tCO₂ reduction (another +15%) requires a high carbon price and comes at a much greater abatement cost of $222.10/tCO₂. This reflects how further emission reductions after maximizing solar self-consumption are more costly, as timing the depot load with the grid marginal emissions factors can compete with minimizing energy and demand charges.

### Tariffs and Net Energy Metering

While the BEV-2-P tariff was designed for customers with flexible business EV loads, not all utilities offer a special EV tariff. We analyze the platform's performance with a more traditional primary commercial customer tariff, the E-20 Primary Firm bundled tariff. E-20-P has lower TOU energy rates than BEV-2-P with a small price spread (less than $0.01/kWh) but considerably higher demand charges. With n_{demand charge}=3 periods, the total demand rate ranges from $40.99/kW to $67.57/kW depending on the season and time of day.

Additionally, while some existing California utility customers with solar are grandfathered into NEM 2.0, for which surplus solar is credited one-to-one (i.e., export rates are equal to import rates), new solar customers as of April 2023 are subjected to NBT, which is also referred to as NEM 3.0. NBT customers have dynamic export rates that are typically very low during solar generating hours, but are greater in the evening, which can only be taken advantage of if they have battery storage to discharge stored solar energy.

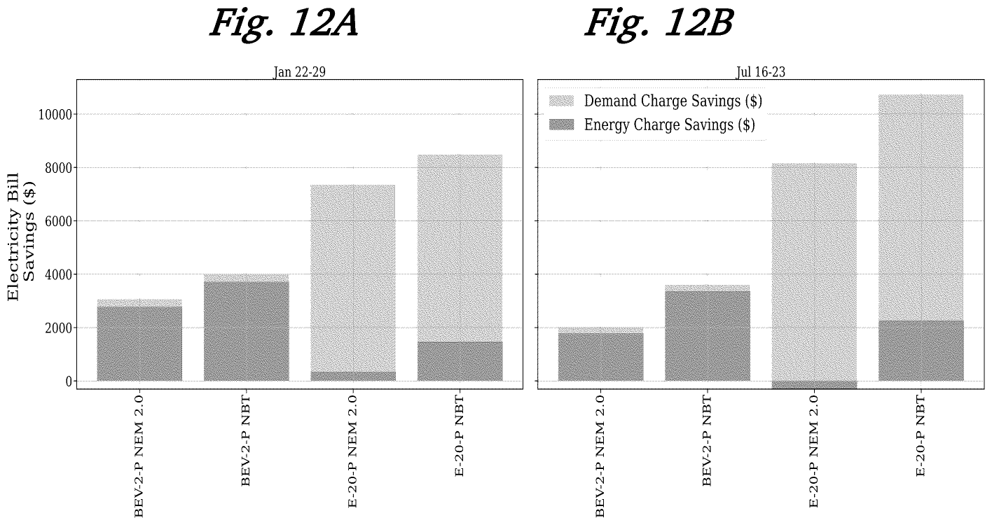

We evaluate the platform's performance under varying tariff selections and net metering policies. FIGS. 12A, 12B show graphs of optimized electricity bill savings for four different combinations of tariffs and net metering policies for winter (FIG. 12A) and summer (FIG. 12B) weeks. Two tariffs, PG&E BEV-2-P and PG&E E-20 Primary Firm, are each evaluated with NEM (e.g., California NEM 2.0) and NBT (e.g., California “NEM 3.0”) policies. Bill savings are greater when the optimized depot is under a NBT policy, particularly in the summer.

We observe that bill savings under BEV-2-P are dominated by energy charge savings while bill savings under E-20-P are dominated by demand charge savings, as expected from the relative sizes of price components of these two tariffs. Also as expected, the absolute electricity bills are greater in both the baseline and optimized cases for scenarios under NBT compared to those under NEM, as export rates are lower on average under NBT. However, our results show that the platform's coordination yields 30% greater average bill savings under the new NBT policy compared to under NEM 2.0, relative to their respective baselines: an average of $6,714 compared to $5,156 per week. These increased savings under the NBT policy are greater in the summer than in the winter, due to greater solar generation. This underscores the elevated importance of adding battery storage and optimizing energy resources for depots that are subjected to the export rates introduced by new NBT policies.

### Conclusion

In this work, we developed a digital twin framework to coordinate electric bus fleet charging, bus assignments, battery storage operations, and solar PV generation. In a case study of an electric bus depot that is metered with campus facilities and subjected to demand charges, our optimized depot reduced emissions by 98% and electricity costs by $180,657 USD annually. Here, installing and optimizing a battery energy storage system provides greatest value in demand charge savings, whereas optimized bus operations provides greatest value in energy charge savings and emissions reductions. In a case study of a stand-alone depot, we achieved 24/7 carbon-free operations for summer and winter weeks, reducing electricity costs by $3,612-$4,010 USD per week. Additionally, we explored the digital twin framework under various tariffs, net metering policies, and carbon prices, demonstrating the framework's adaptability in minimizing of electricity costs and emissions across diverse scenarios. We observe that, with sufficient on-site solar, bus depots can achieve 24/7 decarbonization via solar self-consumption and fully minimizing electricity costs without any consideration of carbon pricing. In contrast, depots with limited solar capacity can increase emission reductions by 17% by introducing carbon pricing, albeit at a $66/tCO₂ carbon abatement cost. Lastly, we observe that an optimized depot is 30% more effective in electricity cost savings under new NBT policies than under NEM 2.0.

This success in cost-effective emissions reduction opens several avenues for future work. First, we will validate the simulated results by deploying the 24/7 CFEF Platform in a pilot demonstration with the Stanford Marguerite Shuttle. Second, we can improve the robustness of the platform to uncertainty by developing forecasting modules for on-site solar generation, marginal carbon emissions factors at local grid nodes, and the upstream campus load profile. Third, the daily scheduling optimization module can be augmented by reinforcement-learning-based approaches for real-time dispatch of the battery storage system, guided by the day-ahead battery scheduler in an hierarchical setup. Finally, we can employ the digital twin framework to enable 24/7 carbon-free operations in other applications, such as electric fleets used by school districts, public transportation, corporate campuses, delivery services, autonomous shuttles, airports, and municipalities.

1. An electric vehicle fleet operations system comprising:
(a) electric vehicle charging stations;
(b) electric energy storage batteries;
(c) solar panels;
wherein the electric vehicle charging stations, the electric energy storage batteries, and the solar panels are connected to each other and to an electrical power distribution grid;
(d) a fleet of electric vehicles adapted to charge using the electric vehicle charging stations;
(e) a forecasting module predicting operational parameters including electricity prices, weather variables, power production of the solar panels, and emission factors of the electrical power distribution grid;
(f) a surrogate module predicting, based on the operational parameters, energy consumption of the fleet of electric vehicles;
(g) an optimization module adapted to compute, based on the operational parameters and the energy consumption, optimal operational tasks for the fleet of electric vehicles and for the electric energy storage batteries,
wherein the optimization module is adapted to determine optimal operational tasks by solving an optimization problem to minimize an objective function that selects the optimal operational tasks to simultaneously minimize electrical energy costs and emissions of the electrical power distribution grid; and
(h) a communications subsystem adapted to communicate the operational tasks to the fleet of electric vehicles and to the electric energy storage batteries.

2. The system of claim 1 wherein the surrogate model uses a Gaussian Process-based surrogate model comprising a probabilistic model that infers a distribution over data points based on known input-output values.

3. The system of claim 1 wherein the surrogate model uses linear regression models, polynomial regression, Gaussian Processes, neural networks, or support vector regression.

4. The system of claim 1 wherein the operational tasks for the fleet of electric vehicles include charging schedules and route assignments.

5. The system of claim 1 wherein the operational tasks for the electric energy storage batteries include charging and discharging schedules.

6. The system of claim 1 wherein solving the optimization problem to minimize the objective function uses mixed integer linear programming.

7. The system of claim 1 wherein solving the optimization problem to minimize the objective function uses Reinforcement Learning-based methods.
